(19) United States
(12) Patent Application Publication
(10) Pub. No.: US 2007/0054999 A1
(43) Pub. Date: Mar. 8, 2007

(54) Coating substances that are free of covering pigments, contain solvents, and can be hardened thermally or by actinic radiation, method for the production thereof, and use thereof same

(76) Inventors: Cornelia Ketteler, Emsdetten (DE); Thomas Farwick, Billerbeck (DE); Vincent Cook, Munster (DE)

Correspondence Address: BASF CORPORATION, 1609 BIDDLE AVENUE, WYANDOTTE, MI, 48192, US

(21) Appl. No.: 10/558,897

(22) PCT Filed: May 21, 2004
(86) PCT No.: PCT/EP04/05467

§ 371 Date: Nov. 30, 2005

(30) Foreign Application Priority Data
Jun. 12, 2003 (DE) 103 26 353.5

(51) Int. Cl. C08L 91/06

(52) U.S. Cl. 524/275

(57) ABSTRACT

The invention relates to coating substances that are free of hiding pigments, contain solvents and are cured thermally or with actinic radiation and also contain at least on of: low molecular mass, oligomeric and polymeric binders, crosslinking agents and reactive diluents that are curable thermally, with actinic radiation, or both thermally and with actinic radiation together with dispersed synthetic polyamide wax particles. The invention also relates to processes for preparing said coatings, and single-coat and multicoat clearcoat systems and multicoat color and/or effect paint systems or adhesives and sealants prepared from said substances.

The present invention relates to new solventborne coating materials curable thermally and/or with actinic radiation and free from hiding pigments. The present invention also relates to a new process for preparing solventborne coating materials curable thermally and/or with actinic radiation and free from hiding pigments. The present invention further relates to the use of the new solventborne coating materials curable thermally and/or with actinic radiation and free from hiding pigments for producing transparent, especially clear, coatings, preferably clearcoats, and especially clearcoats of multicoat color and/or effect paint systems. The present invention relates, furthermore, to the use of the new solventborne coating materials curable thermally and/or with actinic radiation and free from hiding pigments as adhesives and sealants for producing adhesive layers and seals.

Modern automobiles, especially top class automobiles, have multicoat color and/or effect paint systems. These systems, as is known, are made up of an electrocoat, a surfacer coat, antistonechip primer or functional coat, a color and/or effect basecoat, and a clearcoat. The multicoat paint systems are produced using what are known as wet-on-wet techniques, in which a clearcoat film is applied to a dried but uncured basecoat film and then at least basecoat film and clearcoat film are jointly cured thermally. This technique may also embrace the production of the electrocoat and of the surfacer, antistonechip primer or functional coat.

The multicoat color and/or effect paint systems are known to have the so-called automobile quality. According to European patent EP 0 352 298 B1, page 15 line 42 to page 17 line 14 this means that the multicoat paint systems in question score highly for

(1) gloss,

(2) distinctiveness of image (DOI, distinctiveness of the reflected image),

(3) level and uniformity of hiding power,

(4) uniformity of dry film thickness,

(5) gasoline resistance,

(6) solvent resistance,

(7) acid resistance,

(8) hardness,

(9) abrasion resistance,

(10) scratch resistance,

(11) impact strength,

(12) intercoat and substrate adhesion, and

(13) weathering and UV stability.

Further important technological properties are

(14) high resistance to condensation,

(15) absence of propensity toward blushing, and

(16) high stability to tree resin and bird droppings.

In these systems the clearcoats in particular are characterized by such important technological properties as

(1) gloss,

(2) distinctiveness of image (DOI, distinctiveness of the reflected image),

(5) gasoline resistance,

(6) solvent resistance,

(7) acid resistance,

(8) hardness

(9) abrasion resistance

(10) scratch resistance

(13) weathering and UV stability

(14) resistance to condensation

(15) resistance to blushing, and

(16) stability to tree resin and bird droppings.

Accordingly, the requirements imposed on the quality of the clearcoats are particularly stringent.

In addition, however, the technological properties of the clearcoat materials from which these clearcoats are produced are subject to particular requirements. First of all, they must provide the clearcoats in the requisite quality, without problems and with outstanding reproducibility, and they must be preparable with simplicity and with outstanding reproducibility.

Not least they must also be capable of application on the line at the automaker's plant by means of modern application methods, such as pneumatic spray painting with pneumatic manual spray guns and automatic spray guns or electrostatic spray painting (ESTA) with manual spray guns or automatic high-speed rotary bells, in dry film thicknesses of 45 μm or more, without developing runs or pops and without any other problems.

“Running” is the term used for the sagging of applied coating materials on vertical or inclined surfaces, resulting in an unattractive appearance of the resultant coatings. Where it occurs extensively it is also termed “curtaining”. In general a distinction is made between runs at edges and angles and the extensive sagging of coatings on surfaces, referred to simply as “sag”. The reasons for the development of runs may lie in a faulty composition or in incorrect application of coating material.

Where a “run limit” is specified it is generally the wet film thickness of the applied coating material, in μm, above which the first runs occur following spray application of the coating material on a perforated metal panel stood vertical.

(With regard to these phenomena see also Römpp-Online 2002, “Running”, “Run limit”, and “Curtaining”.)

In practice these running phenomena constitute a serious problem, since in the industrial coating of three-dimensional substrates of complex shape, and particularly in automotive EM finishing, they reduce operational reliability and increase the reject rate. For instance, in the finishing of automobile bodies, there is a risk of excessively thick coats building up on sharp edges of the bodies in the case of electrostatic spray application (ESTA). If the thickness of these coats exceeds the stability limit of the coating material in question, the disruptive running phenomena occur during further processing, particularly in the course of drying and of thermal curing.

By craters are meant the always strictly circular depressions that occur, in some instances singly, in others en masse, in paint systems, these depressions occurring with or without a rim, which barely exceeds the mm range and is usually well below. The causes of these craters, despite their uniform appearance, are very different, with the consequence that in practice it is particularly difficult to prevent cratering (cf. Römpp-Online 2002, “Crater(ing)”).

The existing solventborne clearcoat materials curable thermally and/or with actinic radiation and free from hiding pigments are frequently unable to prevent the development of runs in craters in the clearcoats produced from them, especially clearcoats of multicoat color and/or effect paint systems. In order to solve the problems the automakers often reduce the film thickness of the clearcoats, a measure which, however, can severely impair such important performance properties as gloss, distinctiveness of image, and weathering and UV stability and lead to dulling of the clearcoats. On the part of the clearcoat manufacturers attempts are made to prevent the problems through the addition of relatively large amounts of conventional rheological assistants of rheological control additives, such as the sag control agents (SCAs) known from applications WO 94/22968 A1, EP 0 276 501 A1, EP 0 249 201 A1 or WO 97/12945 A1; the crosslinked polymeric microparticles as disclosed for example in EP 0 008 127 A1; the inorganic phyllosilicates such as aluminum magnesium silicates, sodium magnesium, and sodium magnesium fluorine lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, polyvinylpyrrolidone, styrene-maleic anhydride or ethylene-maleic anhydride copolymers and their derivatives, or hydrophobically modified ethoxylated urethanes or polyacrylates. Such measures can, however, result in a deterioration of the topcoat appearance, since they affect the leveling of the clearcoat materials.

The use of polyamides as thickeners for solventborne coating materials is known from the textbook “Lackadditive” [Additives for coatings] by Johan Bieleman, Wiley-VCH, Weinheim, New York, 1998, page 62. In addition it is known, from technical data sheet II. 20.3 from C. H. Erbslöh, “DISPARLON 6900-20X”, October 1986, to use swollen particles of synthetic polyamide wax as antirun/antisettling agents for resins and solvents, high-build coatings of epoxy resins, tar/epoxy resin mixtures, tar/polyurethane mixtures, and chlorinated rubber, aluminum pigments in automotive finishes, heavy pigments in rustproofing coatings and carpet backing coatings and gel coatings (glass fiber plastics). Whether these swollen particles of synthetic polyamide wax are capable of solving the problems addressed above is unknown.

It is an object of the present invention to find new solventborne coating materials free from hiding pigments and curable thermally and/or with actinic radiation, in particular thermally, which no longer have the disadvantages of the prior art but which instead provide new transparent, especially clear, coatings, preferably clearcoats, especially clearcoats of multicoat color and/or effect paint systems, which exhibit automobile quality and no longer feature any runs, craters or instances of dulling.

The invention accordingly provides the new solventborne coating materials curable thermally and/or with actinic radiation and free from hiding pigments, comprising
(A) at least one constituent selected from the group consisting of low molecular mass, oligomeric, and polymeric binders, crosslinking agents, and reactive diluents curable thermally, with actinic radiation, or both thermally and with actinic radiation; and
(B) from 0.01 to 4% by weight, based on the coating material, of dispersed synthetic polyamide wax particles.

The new solventborne coating materials curable thermally and with actinic radiation and free from hiding pigments are referred to below as “coating materials of the invention”.

Further subject matter of the invention will emerge from the description.

In the light of the prior art it was surprising and unforeseeable for the skilled worker that the object on which the present invention was based could be achieved through the inventive use of the additive (B). A particular surprise was that the additive (B) was extremely effective even in small amounts with regard to the prevention of runs, craters, and dulling. Moreover it was surprising that the coatings of the invention produced from the coating materials of the invention, preferably the clearcoats of the invention and especially the clearcoats of the invention in multicoat color and/or effect paint systems, had the automobile quality described at the outset and no longer featured any runs, craters or dulling.

The coating materials of the invention are curable thermally and/or with actiric radiation. On thermal curing refer to Römpp-Online 2002 “Curing”. Actinic radiation refers here and below to electromagnetic radiation, such as near infrared (NIR), visible light, UV radiation, X-rays, and gamma radiation, especially LTV radiation, and corpuscular radiation, such as electron beams, beta radiation, proton beams, neutron beams, and alpha radiation, especially electron beams. Combined curing with heat and actinic radiation is also referred to as dual cure.

The coating materials of the invention curable thermally or both thermally and with actinic radiation can be one-component systems, in which all of the constituents necessary for thermal curing can be present alongside one another at below 100° C. without any premature curing. Alternatively they can be multicomponent systems, especially two-component systems, in which at least two of the constituents necessary for thermal curing must be stored separately from one another prior to their application, on account of their high reactivity: examples include hydroxyl-containing compounds and polyisocyanates.

In particular the coating materials of the invention are thermally curing one-component systems.

The key constituent of the coating materials of the invention is at least one, especially one, additive (B). The additive (B) comprises synthetic polyamide wax particles. The synthetic polyamide wax particles (B) are preferably dispersed in and swollen by the organic solvents (C) of the coating materials of the invention.

The synthetic polyamide wax particles (B) preferably have a melting point or melting range above 100° C., preferably above 120° C., and more preferably above 130° C. The melting point or melting range is preferably below 200° Celsius, preferably below 180° C. and more preferably below 160° C. In particular they have a melting point or melting range of 132 to 136° C.

Their average particle size is preferably below the film thickness of the coating of the invention produced from the coating material of the invention in question. The average particle size is preferably below 100 μm, more preferably below 80 μm, very preferably below 60 μm, and in particular below 50 μm. A specific range of particular advantage is that from 5 to 40 μm.

In accordance with the invention the additive (B) is present in the coating materials of the invention in an amount, based in each case on the coating material, of from 0.01 to 3%, preferably from 0.02 to 3.8%, more preferably from 0.03 to 3.6%, very preferably from 0.04 to 3.4%, and in particular from 0.05 to 3.2% by weight.

The synthetic polyamide wax particles (B) for use in accordance with the invention can be added as they are to the coating materials of the invention. It is of advantage, however, to add them in the form of a dispersion in organic solvents (C). The solids content of the dispersion may vary widely; preferably it contains the additive (B) for use in accordance with the invention in an amount, based on the total dispersion amount, of from 5 to 40%, more preferably from 10 to 30%, and in particular from 15 to 25% by weight. It is especially advantageous to use the additive (B) for use in accordance with the invention in the form of a paste (A/B) preferably containing, based on the paste (A/B), from 20 to 60%, more preferably from 25 to 55%, and in particular from 30 to 50% by weight of at least one, especially one, of the binders (A) described below and from 3 to 9%, more preferably from 4 to 8%, and in particular from 5 to 7% by weight of the additive (B) and also at least one organic solvent (C). It is especially advantageous if the binder (A) used in the paste (A/B) is identical with the binder (A) of the particular coating material of the invention.

The solids content of the pastes (A/B) is preferably from 30 to 80%, more preferably from 35 to 70%, and in particular from 40 to 60% by weight, based on the paste (A/B).

Preference is given to using organic solvents (C) which do not inhibit the crosslinking of coating materials of the invention and/or do not enter into any disruptive interactions with the other constituents of the coating materials of the invention. The skilled worker can therefore select suitable solvents easily on the basis of their known solvency and their reactivity. Examples of suitable solvents are known from D. Stoye and W. Freitag (Editors), “Paints, Coatings and Solvents”, Second, Completely Revised Edition, Wiley-VCH, Weinheim, New York, 1998, “14.9. Solvent Groups”, pages 327 to 373.

The dispersions of the additives (B) in organic solvents (C) are commercially customary products and are sold for example under the brand name Disparlon®, in particular Disparlon® 6900-20X, by the company C. H. Erbslöh.

The further key constituent of the coating materials of the invention is at least one constituent (A) selected from the group consisting of low molecular mass, oligomeric, and polymeric binders, crosslinking agents, and reactive diluents curable thermally, with actinic radiation, or both thermally and with actinic radiation.

Low molecular mass constituents (A) are considered those consisting essentially of just one parent structure or one monomer unit. Low molecular mass constituents generally have number-average molecular weights of less than 1000 daltons. Oligomeric constituents (A) contain generally 2 to 15 monomer units; polymeric constituents contain generally more than 10, in particular more than 15, monomer units (cf. also Römpp-Online 2002, “Oligomers”, “Polymers”).

The constituent (A) is selected per se, or the constituents (A) are selected in their entirety, such that the resulting coating materials of the invention have the desired curing properties. In particular the coating materials of the invention comprise at least one binder and at least one crosslinking agent as constituents (A).

The binders (A) are preferably selected from the group consisting of random, alternating, and block, linear, branched, and comb addition (co)polymers of ethylenically unsaturated monomers, polyaddition resins and/or polycondensation resins curable physically, thermally or both thermally and with actinic radiation. Regarding these terms, refer to Römpp Lexikon Lacke und Druckfarben, Georg Thieme Verlag, Stuttgart, New York, 1998, page 457, “Polyaddition” and “Polyaddition resins (polyadducts)”, and pages 463 and 464, “Polycondensates”, “Polycondensation”, and “Polycondensation resins”, and also pages 73 and 74, “Binders”.

Examples of suitable addition (co)polymers (A) are (meth)acrylate (co)polymers or partially hydrolyzed polyvinyl esters, especially (meth)acrylate copolymers.

Examples of suitable polyaddition resins and/or polycondensation resins (A) are polyesters, alkyds, polyurethanes, polylactones, polycarbonates, polyethers, epoxy resin-amine adducts, polyureas, polyamides, polyimides, polyester-polyurethanes, polyether-polyurethanes or polyester-polyether-polyurethanes, especially polyesters.

The binders (A) curable thermally and/or with actinic radiation can contain on average per molecule
(i) at least one, in particular at least two, reactive functional group(s) which can enter into thermally initiated crosslinking reactions with complementary reactive functional groups, and/or
(ii) at least one, in particular at least two, reactive functional group(s) having at least one, especially one, bond which can be activated with actinic radiation.

Examples of suitable complementary reactive functional groups (i) for use in accordance with the invention are set out in the overview below. In the overview the variable R stands for an acyclic or cyclic aliphatic radical, an aromatic radical and/or an aromatic-aliphatic (araliphatic) radical; the variables R′ and R″ stand for identical or different aliphatic radicals or are linked with one another to form an aliphatic or heteroaliphatic ring.

Overview: Examples of Complementary Reactive Functional Groups (i)

Binder and crosslinking agent or
Crosslinking agent and binder

| | |
|---|---|
| —SH | —C(O)—OH |
| —NH₂ | —C(O)—O—C(O) |
| —O—(CO)—NH—(CH)—NH₂ | —NCO |
| —O—(CO)—NH₂ | —NH—C(O)—OR |
| >NH | —CH₂—OH |
| | —CH2—O—R |
| | —NH—CH₂—O-R |
| | —NH—CH₂—OH |
| | —N(—CH₂—O-R)₂ |
| | —NH—C(O)—CH(—C(O)OR)₂ |
| | —NH—C(O)—CH(—C(O)OR)(—C(O)—R) |
| | —NH—C(O)—NR′R″ |
| | >Si(OR)₂ |
| | 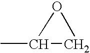 |
| | 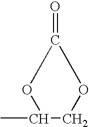 |
| —C(O)—OH | 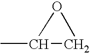 |
| | —C(O)—N(CH₂—CH₂—OH)₂ |

The selection of the respective complementary reactive functional groups (i) is guided on the one hand by the consideration that, during the preparation of the binders (A) and also during the preparation, storage, application, and curing operation, they must not enter into any unwanted reactions, in particular no premature crosslinking, and/or must not inhibit or disrupt the curing with actinic radiation, and on the other hand by the temperature range within which crosslinking is to take place.

The complementary reactive functional groups (i) are preferably selected on the one hand from the group consisting of hydroxyl, thiol, amino, N-methylolamino, N-alkoxymethylamino, imino, carbamate, allophanate and/or carboxyl groups and on the other hand from the group consisting of anhydride, carboxyl, epoxy, blocked and nonblocked isocyanate, urethane, alkoxycarbonylamino, methylol, methylol ether, carbonate, amino and/or beta-hydroxyalkylamide groups.

Self-crosslinking binders (A) contain in particular methylol, methylol ether and/or N-alkoxymethylamino groups (i).

Particular preference is given to using hydroxyl groups on the one hand and blocked isocyanate groups and N-methylolamino and N-alkoxymethylamino groups on the other as complementary reactive functional groups (i).

The reactive functional groups (ii) having at least one bond which can be activated with actinic radiation may be present alongside the groups (i) in the binders (A) (dual-cure binders) or are the sole groups capable of crosslinking (binders curable with actinic radiation).

In the context of the present invention a bond which can be activated with actinic radiation is a bond which on exposure to actinic radiation becomes reactive and, together with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus and/or carbon-silicon single bonds or double bonds, or carbon-carbon triple bonds. Of these, the carbon-carbon double bonds are particularly advantageous and are therefore used with very particular preference in accordance with the invention. For the sake of brevity they are referred to below as “double bonds”.

The inventively preferred group (ii), accordingly, contains one double bond or two, three or four double bonds. Where more than one double bond is used the double bonds can be conjugated. In accordance with the invention, however, it is of advantage if the double bonds are present in isolation, in particular each terminally, in the group (ii) in question. It is especially advantageous in accordance with the invention to use two double bonds or, in particular, one.

The dual-cure binder or the binder (A) curable with actinic radiation contains on average at least one of the above-described groups (ii) which can be activated with actinic radiation. This means that the functionality of the binder in this respect is integral, i.e., for example, is two, three, four, five or more, or nonintegral, i.e., for example, is from 2.1 to 10.5 or more.

Where on average more than one group (ii) which can be activated with actinic radiation per molecule is employed the groups (ii) are structurally different from one another or of identical structure.

Where they are structurally different from one another this means in the context of the present invention that two, three, four or more, but especially two, groups (ii) which can be activated with actinic radiation are used which derive from two, three, four or more, especially two, monomer classes.

Examples of suitable groups (ii) are (meth)acrylate, ethacrylate, crotonate, cinnamate, vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, allyl ether or butenyl ether groups, or dicyclopentadienyl ester, norbornenyl ester, isoprenyl ester, isopropenyl ester, allyl ester or butenyl ester groups, but especially acrylate groups.

The groups (ii) are attached to the respective parent structures of the binders (A) preferably by way of urethane, urea, allophanate, ester, ether and/or amide groups, but in particular by way of ester groups. Normally this occurs as a result of conventional polymer-analogous reactions such as, for instance, the reaction of pendant glycidyl groups with the olefinically unsaturated monomers described below which contain an acid group; of pendant hydroxyl groups with the halides of these monomers; of hydroxyl groups with isocyanates containing double bonds such as vinyl isocyanate, methacryloyl isocyanate and/or 1-(1-isocyanato-1-methylethyl)-3-(1-methylethenyl)benzene (TMI® from CYTEC); or of isocyanate groups with the hydroxyl-containing monomers described below.

Of these binders (A), the (meth)acrylate copolymers and the polyesters, particularly (meth)acrylate copolymers, especially the hydroxyl-containing (meth)acrylate copolymers, have particular advantages and are therefore used with particular preference.

The preferred coating material for use in accordance with the invention accordingly comprises preferably at least one, in particular one, hydroxyl-containing (meth)acrylate copolymer (A) as binder. In some cases, however, it may be advantageous to use at least two, in particular two, hydroxyl-containing (meth)acrylate copolymers (A) which have a different profile of properties within the bounds of the preferred ranges indicated below for OH number, glass transition temperature, and number-average and mass-average molecular weight.

The (meth)acrylate copolymer (A) preferably has
an OH number of from 100 to 220, more preferably from 130 to 200, very preferably from 140 to 190, and in particular from 145 to 180 mg KOH/g,
a glass transition temperature of from −35 to +60° C., in particular from −20 to +40° C.,
a number-average molecular weight of from 1,000 to 10,000 daltons, in particular from 1,500 to 5,000 daltons, and
a mass-average molecular weight of from 2,000 to 40,000 daltons, in particular from 3,000 to 20,000 daltons.

Preferably the (meth)acrylate copolymer (A) contains in copolymerized form an amount, corresponding to its OH number, of hydroxyl-containing olefinically unsaturated monomers (a), of which
(a1) from 20 to 90%, more preferably from 22 to 85%, very preferably from 25 to 80%, and in particular from 28 to 75% by weight, based in each case on the hydroxyl-containing monomers (a), are selected from the group consisting of 4-hydroxybutyl (meth)acrylate and 2-alkylpropane-1,3-diol mono(meth)acrylates and
(a2) from 20 to 80%, more preferably from 15 to 78%, very preferably from 20 to 75%, and in particular from 25 to 72% by weight, based in each case on the hydroxyl-containing monomers (a), are selected from the group consisting of other hydroxyl-containing olefinically unsaturated monomers.

Examples of suitable 2-alkylpropane-1,3-diol mono(meth)acrylates (a1) are 2-methyl-, 2-ethyl-, 2-propyl-, 2-isopropyl- or 2-n-butyl-propane-1,3-diol mono(meth)acrylate, of which 2-methylpropane-1,3-diol mono(meth)acrylate is particularly advantageous and is used with preference.

Examples of suitable other hydroxyl-containing olefinically unsaturated monomers (a2) are hydroxyalkyl esters of olefinically unsaturated carboxylic, sulfonic, and phosphonic acids and acidic phosphoric and sulfuric esters, especially carboxylic acids, such as acrylic acid, beta-carboxyethyl acrylate, methacrylic acid, ethacrylic acid, and crotonic acid, in particular acrylic acid and methacrylic acid. They are derived from an alkylene glycol, which is esterified with the acid, or are obtainable by reacting the acid with an alkylene oxide such as ethylene oxide or propylene oxide. It is preferred to use the hydroxyalkyl esters in which the hydroxyalkyl group contains up to 20 carbon atoms, especially 2-hydroxyethyl or 3-hydroxypropyl acrylate or methacrylate; 1,4-bis(hydroxymethyl)cyclohexane or octahydro-4,7-methano-1H-indenedimethanol monoacrylate or monomethacrylate; or reaction products of cyclic esters, such as epsilon-caprolactone for example, and these hydroxyalkyl esters; or olefinically unsaturated alcohols such as allyl alcohol; or polyols, such as trimethylolpropane monoallyl or diallyl ether or pentaerythritol monoallyl, diallyl or triallyl ether. These higher polyfunctional monomers (a2) are generally used only in minor amounts. In the context of the present invention minor amounts of higher polyfunctional monomers (a2) are amounts which do not lead to crosslinking or gelling of the (meth)acrylate copolymers (A), unless the intention is that they should be in the form of crosslinked microgel particles.

Further suitable monomers (a2) include ethoxylated and/or propoxylated allyl alcohol, which is sold by Arco Chemicals, or 2-hydroxyalkyl allyl ethers, especially 2-hydroxyethyl allyl ethers. Where used they are employed preferably not as sole monomers (a2) but rather in an amount of from 0.1 to 10% by weight, based on the (meth)acrylate copolymer (A).

Also suitable are reaction products of the olefinically unsaturated acids set out above, especially acrylic acid and/or methacrylic acid, with the glycidyl ester of an alpha-branched monocarboxylic acid having 5 to 18 carbon atoms per molecule, in particular a Versatic® acid, or, instead of the reaction products, an equivalent amount of the olefinically unsaturated acids set out above, especially acrylic and/or methacrylic acid, which is then reacted, during or after the polymerization reaction, with the glycidyl ester of an alpha-branched monocarboxylic acid having 5 to 18 carbon atoms per molecule, in particular a Versatic® acid (cf. Römpp Lexikon Lacke und Druckfarben, Georg Thieme Verlag, Stuttgart, New York, 1998, “Versatic® acids”, pages 605 and 606).

Suitable not least as monomers (a2) are acryloyloxysilane-containing vinyl monomers, which are preparable by reacting hydroxy-functional silanes with epichlorohydrin and then reacting that reaction product with (meth)acrylic acid and/or hydroxyalkyl and/or hydroxycycloalkyl esters of (meth)acrylic acid and/or further hydroxyl-containing monomers (a1) and (a2).

The complementary reactive functional groups (i) can be introduced into the (meth)acrylate copolymers with the aid of the olefinically unsaturated monomers (a3), described below, which contain the reactive functional groups (i) in question, or by means of polymer-analogous reactions.

Examples of suitable olefinically unsaturated monomers (a3) are
(a31) monomers which carry at least one amino group per molecule, such as
   aminoethyl acrylate, aminoethyl methacrylate, allylamine or N-methyliminoethyl acrylate; and/or
(a32) monomers which carry at least one acid group per molecule, such as
   acrylic acid, beta-carboxyethyl acrylate, methacrylic acid, ethacrylic acid, crotonic acid, maleic acid, fumaric acid or itaconic acid;
   olefinically unsaturated sulfonic or phosphonic acids or their partial esters;
   mono(meth)acryloyloxyethyl maleate, succinate or phthalate; or
   vinylbenzoic acid (all isomers), alpha-methylvinylbenzoic acid (all isomers) or vinylbenzenesulfonic acid (all isomers); and/or
(a33) monomers containing epoxide groups, such as the glycidyl ester of acrylic acid, methacrylic acid, ethacrylic acid, crotonic acid, maleic acid, fumaric acid or itaconic acid or allyl glycidyl ether.

One example of the introduction of reactive functional groups (i) by way of polymer-analogous reactions is the reaction of some of the hydroxyl groups present in the binder (A) with phosgene, giving resins containing chloroformate groups, and the polymer-analogous reaction of the chloroformate-functional resins with ammonia and/or primary and/or secondary amines to give binders (A) containing carbamate groups. Further examples of suitable methods of this kind are known from patents U.S. Pat. No. 4,758,632 A1, U.S. Pat. No. 4,301,257 A1 or U.S. Pat. No. 2,979,514 A1. A further possibility is to introduce carboxyl groups by the polymer-analogous reaction of some of the hydroxyl groups with carboxylic anhydrides, such as maleic anhydride or phthalic anhydride.

Furthermore the (meth)acrylate copolymers (A) may include at least one olefinically unsaturated monomer (a4), these monomers being substantially or entirely free from reactive functional groups and including:

Monomers (a41):

(Meth)acrylic esters substantially free of acid groups, such as (meth)acrylic acid alkyl or cycloalkyl esters having up to 20 carbon atoms in the alkyl radical, especially methyl, ethyl, n-propyl, n-butyl, sec-butyl, tert-butyl, hexyl, ethylhexyl, stearyl and lauryl acrylate or methacrylate; cycloaliphatic (meth)acrylic esters, especially cyclohexyl, isobomyl, dicyclopentadienyl, octahydro-4,7-methano-1H-indenemethanol or tert-butylcyclohexyl (meth)acrylate; (meth)acrylic acid oxaalkyl esters or oxacycloalkyl esters such as ethoxytriglycol (meth)acrylate and methoxyoligoglycol (meth)acrylate having a molecular weight Mn of preferably 550, or other ethoxylated and/or propoxylated, hydroxyl-free (meth)acrylic acid derivatives (further examples of suitable monomers (a41) of this kind are known from laid-open specification DE 196 25 773 A1, column 3, line 65 to column 4, line 20). In minor amounts they may contain higher polyfunctional (meth)acrylic acid alkyl or cycloalkyl esters such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate; trimethylolpropane di- or tri(meth)acrylate; or pentaerthrytol di-, tri- or tetra(meth)acrylate. For the purposes of the present invention minor amounts of higher polyfunctional monomers (a41) here are amounts which do not lead to crosslinking or gelling of the copolymers, unless the intention is that they should be in the form of crosslinked microgel particles.

Monomers (a42):

Vinyl esters of alpha-branched monocarboxylic acids having 5 to 18 carbon atoms in the molecule. The branched monocarboxylic acids can be obtained by reacting formic acid or carbon monoxide and water with olefins in the presence of a liquid, strongly acidic catalyst; the olefins can be products from the cracking of paraffinic hydrocarbons, such as mineral oil fractions, and may contain both branched and straight-chain acyclic and/or cycloaliphatic olefins. The reaction of such olefins with formic acid or with carbon monoxide and water produces a mixture of carboxylic acids in which the carboxyl groups are located predominantly on a quaternary carbon atom. Other olefinic starting materials are, for example, propylene trimer, propylene tetramer, and diisobutylene. Alternatively the vinyl esters can be prepared conventionally from the acids, for example, by reacting the acid with acetylene. Particular preference, owing to their ready availability, is given to using vinyl esters of saturated aliphatic monocarboxylic acids having 9 to 11 carbon atoms which are branched on the alpha carbon atom. Vinyl esters of this kind are sold under the brand name VeoVa® (cf. also Römpp Lexikon Lacke und Druckfarben, Georg Thieme Verlag, Stuttgart, New York, 1998, page 598).

Monomers (a43):

Diarylethylenes, particularly those of the general formula I:
R¹R²C═CR³R⁴ (1),
in which the radicals R¹, R², R³ and R⁴ each independently of one another stand for hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals with the proviso that at least two of the variables R¹, R², R³ and R⁴ stand for substituted or unsubstituted aryl, arylalkyl or arylcycloalkyl radicals, especially substituted or unsubstituted aryl radicals. Examples of suitable alkyl radicals are methyl, ethyl, propyl, isopropyl, n-butyl, isobutyl, tert-butyl, amyl, hexyl or 2-ethylhexyl. Examples of suitable cycloalkyl radicals are cyclobutyl, cyclopentyl or cyclohexyl. Examples of suitable alkylcycloalkyl radicals are methylenecyclohexane, ethylenecyclohexane or propane-1,3-diylcyclohexane. Examples of suitable cycloalkylalkyl radicals are 2-, 3- or 4-methyl-, -ethyl-, -propyl- or -butylcyclohex-1-yl. Examples of suitable aryl radicals are phenyl, naphthyl or biphenylyl, preferably phenyl and naphthyl, and especially phenyl. Examples of suitable alkylaryl radicals are benzyl or ethylene- or propane-1,3-diyl-benzene. Examples of suitable cycloalkylaryl radicals are 2-, 3- or 4-phenylcyclohex-1-yl. Examples of suitable arylalkyl radicals are 2-, 3- or 4-methyl-, -ethyl-, -propyl- or -butylphen-1-yl. Examples of suitable arylcycloalkyl radicals are 2-, 3- or 4-cyclohexylphen-1-yl. The aryl radicals R¹, R², R³ and/or R⁴ are preferably phenyl or naphthyl radicals, especially phenyl radicals. The substituents present if desired in the radicals R¹, R², R³ and/or R⁴ are electron-withdrawing or electron-donating atoms or organic radicals, especially halogen atoms, nitrile, nitro, partially or fully halogenated alkyl, cycloalkyl, alkylcycloalkyl, cycloalkylalkyl, aryl, alkylaryl, cycloalkylaryl, arylalkyl, and arylcycloalkyl radicals; aryloxy, alkyloxy, and cycloalkyloxy radicals; and/or arylthio, alkylthio, and cycloalkylthio radicals. Particular advantage is possessed by diphenylethylene, dinaphthaleneethylene, cis- or trans-stilbene or vinylidenebis(4-nitrobenzene), especially diphenylethylene (DPE), which are therefore used with preference. In the context of the present invention the monomers (a43) are used in order to regulate the copolymerization advantageously in such a way as to enable free-radical copolymerization in batch mode.

Monomers (a44):

Vinylaromatic hydrocarbons such as styrene, vinyltoluene, diphenylethylene or alpha-alkylstyrenes, especially alpha-methylstyrene.

Monomers (a45):

Nitriles such as acrylonitrile and/or methacrylonitrile.

Monomers (a46):

Vinyl compounds, especially vinyl halides and/or vinylidene dihalides such as vinyl chloride, vinyl fluoride, vinylidene dichloride or vinylidene difluoride; N-vinyl amides such as vinyl-N-methylformamide, N-vinylcaprolactam or N-vinyl-pyrrolidone; 1-vinylimidazole; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.

Monomers (a47):

Allyl compounds, especially allyl ethers and allyl esters such as allyl methyl, ethyl, propyl or butyl ether or allyl acetate, propionate or butyrate.

Monomers (a48):

Polysiloxane macromonomers which have a number-average molecular weight Mn of from 1,000 to 40,000 and contain on average from 0.5 to 2.5 ethylenically unsaturated double bonds per molecule; especially polysiloxane macromonomers having a number-average molecular weight Mn of from 2,000 to 20,000, more preferably from 2,500 to 10,000, and in particular from 3,000 to 7,000 and containing on average from 0.5 to 2.5, preferably from 0.5 to 1.5, ethylenically unsaturated double bonds per molecule, as described in DE 38 07 571 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1 or in the international patent application WO 92/22615 on page 12, line 18 to page 18, line 10.

The monomers (a1) and (a2) and also (a3) and/or (a4) are selected so as to result in the OH numbers and glass transition temperatures indicated above. Moreover the monomers (a3) which contain reactive functional groups (i) are selected in nature and amount so that they do not inhibit or prevent entirely the crosslinking reactions of the hydroxyl groups with the compounds (C) described below.

The selection of the monomers (a) for the purpose of adjusting the glass transition temperatures may be made by the skilled worker with the assistance of the following formula of Fox, which can be used to make an approximate calculation of the glass transition temperatures of poly(meth)acrylates:
n=x
1/Tg=ΣWn/Tgₙ; ΣₙWₙ=1
n=1
Tg=glass transition temperature of the poly(meth)acrylate;
Wₙ=weight fraction of the nth monomer;
Tgₙ=glass transition temperature of the homopolymer of the nth monomer; and
X=number of different monomers.

The preparation of the (meth)acrylate copolymers (A) for preferred use has no special features in terms of process but instead takes place by means of the methods familiar in the plastics field of continuous or batchwise free-radically initiated copolymerization in bulk, solution, emulsion, miniemulsion or microemulsion under atmospheric or superatmospheric pressure in stirred tanks, autoclaves, tube reactors, loop reactors or Taylor reactors at temperatures of preferably 50 to 200° C.

Examples of suitable copolymerization processes are described in patent applications DE 197 09 465 A1, DE 197 09 476 A1, DE 28 48 906 A1, DE 195 24 182 A1, DE 198 28 742 A1, DE 196 28 143 A1, DE 19628 142 A1, EP 0 554783 A1, WO 95/27742 A1, WO 82/02387 A1 or WO 98/02466 A1. Alternatively the copolymerization can be carried out in polyols (thermally curable reactive diluents) as reaction medium, as described for example in German patent application DE 198 50 243 A1.

Examples of suitable free-radical initiators are dialkyl peroxides, such as di-tert-butyl peroxide or dicumyl peroxide; hydroperoxides, such as cumene hydroperoxide or tert-butyl hydroperoxide; peresters, such as tert-butyl perbenzoate, tert-butyl perpivalate, tert-butylper-3,5,5-trimethylhexanoate or tert-butyl per-2-ethylhexanoate; peroxodicarbonates; potassium, sodium or ammonium peroxodisulfate; azo initiators, examples being azo dinitriles such as azobisisobutyronitrile; C—C-cleaving initiators such as benzpinacol silyl ethers; or a combination of a nonoxidizing initiator with hydrogen peroxide. It is also possible to employ combinations of the initiators described above.

Further examples of suitable initiators are described in German patent application DE 196 28 142 A1, page 3, line 49 to page 4, line 6.

It is preferred to add comparatively large amounts of free-radical initiator, with the proportion of the initiator in the reaction mixture, based in each case on the total amount of the monomers (a) and of the initiator, being preferably from 0.2 to 20% by weight, more preferably from 0.5 to 15% by weight, and in particular from 1.0 to 10% by weight.

In addition it is possible to use thiocarbonylthio compounds or mercaptans such as dodecyl mercaptan as chain transfer agents or molecular weight regulators.

The nature and amount of the (meth)acrylate copolymers (A) are preferably selected so that the coating materials of the invention after they have cured have a storage modulus E′ in the rubber-elastic range of at least 10^{7.5} Pa and a loss factor tan δ at 20° C. of not more than 0.10, the storage modulus E′ and the loss factor having been measured by means of dynamic mechanical thermoanalysis on free films having a thickness of 40±10 μm (in this regard cf. German patent DE 197 09 467 C2).

The amount of the binders (A) in the coating materials of the invention can vary widely and is guided primarily with a functionality of the binders (A) on the one hand and the compounds (A) described below, where present, on the other hand. The amount, based on the solids of the coating material of the invention, is preferably from 10 to 99.8%, more preferably from 15 to 95%, very preferably from 15 to 90%, more preferably still from 15 to 85%, and in particular from 15 to 80% by weight.

The coating materials of the invention preferably further include at least one constituent selected from the group consisting of low molecular mass compounds (A) different than the binders (A) and low molecular mass, oligomeric, and polymeric compounds (A) which contain on average per molecule
(i) at least one, preferably at least two, of the above-described reactive functional groups (i) which are able to enter into thermally initiated crosslinking reactions with complementary reactive functional groups (i), in particular hydroxyl groups; i.e., purely thermally curable reactive diluents and/or crosslinking agents; and/or
(ii) at least one, preferably at least two, of the above-described reactive functional groups (ii) having at least one bond which can be activated with actinic radiation, i.e., purely actinic-radiation-curable reactive diluents and/or crosslinking agents or dual-cure reactive diluents and/or crosslinking agents.

Examples of suitable purely thermally curable crosslinking agents (A) are known, for example, from German patent application DE 199 24 171 A1, page 7, line 38 to page 8, line 46 in conjunction with page 3, line 43 to page 5, line 31. Preference is given to employing blocked, partially blocked or nonblocked polyisocyanates and amino resins.

Examples of suitable purely thermic curable reactive diluents (A) are low molecular mass polyols, such as diethyloctanediols.

Examples of suitable low molecular mass, oligomeric and/or polymeric reactive diluents (A) curable purely with actinic radiation and having at least one group (ii) are described in detail in Römpp Lexikon Lacke und Druckfarben, Georg Thieme Verlag, Stuttgart, New York, 1998, “Reactive diluents”, pages 491 and 492, in German patent application DE 199 08 013 A1, column 6, line 63 to column 8, line 65, in German patent application DE 199 08 018 A1, page 11, lines 31 to 33, in German patent application DE 198 18 735 A1, column 7, lines 1 to 35, or in German patent DE 197 09 467 C1, page 4, line 36 to page 5, line 56. Preference is given to using pentaerythritol tetraacrylate, dipentaerythritol pentaacrylate and/or aliphatic urethane acrylates having six acrylate groups in the molecule.

Instead of the compounds (A) described above or in addition to them the coating materials of the invention may contain at least one, in particular at least two, low molecular mass, oligomeric and/or polymeric compound(s) (A) having at least one, in particular at least two, group(s) (i) and at least one, in particular at least two, group(s) (ii). These compounds (A) are simultaneously dual-cure crosslinking agents and dual-cure reactive diluents. Examples of suitable dual-cure crosslinking agents/reactive diluents (A) of this-kind are described in detail in European patent application EP 0 928 800 A1, page 3, lines 17 to 54 and page 4, lines 41 to 54, or in German patent application DE 198 18 735 A1, column 3, line 16 to column 6, line 33. Preference is given to using isocyanato acrylates which are preparable from polyisocyanates and the above-described hydroxyl-containing monomers (a1) and/or (a2).

The coating materials of the invention further include at least one organic solvent (C). Examples of suitable organic solvents are those described above in connection with the additive (B) for use in accordance with the invention.

The coating materials of the invention may further comprise at least one conventional additive (D) in the conventional, effective amounts, preferably selected from the group consisting of molecularly dispersely soluble dyes; light stabilizers, such as UV absorbers and reversible free-radical scavengers (HALS); antioxidants; wetting agents; emulsifiers; slip additives; polymerization inhibitors; thermal crosslinking catalysts; thermolabile free-radical initiators; photoinitiators; adhesion promoters; leveling agents; film-forming auxiliaries; other, non-(B) rheological assistants; flame retardants; corrosion inhibitors; free-flow aids; waxes; siccatives; biocides; and flatting agents.

Examples of suitable additives (D) are described in detail in the textbook “Lackadditive” by Johan Bieleman, Wiley-VCH, Weinheim, New York, 1998, in D. Stoye and W. Freitag (Editors), “Paints, Coatings and Solvents”, Second, Completely Revised Edition, Wiley-VCH, Weinheim, New York, 1998, “14.9. Solvent Groups”, pages 327 to 373, in German patent application DE 199 14 896 A1, column 14, line 26 to column 15, line 46, or in German patent application DE 199 08 018 A1, page 9, line 31 to page 8, line 30. For further details refer to German patent applications DE 199 04 317 A1 and DE 198 55 125 A1.

The coating materials of the invention may further comprise nonhiding, transparent pigments (E), particularly nanoparticles (E).

The solids content of the coating materials of the invention may vary very widely. It is guided in particular by the constituents used in each instance, the application characteristics, and the intended use of the coating materials. Where, for example, the composition of the coating materials of the invention is made such that they are curable thermally or both thermally and with actinic radiation, their application solids content is preferably above 40% and in particular above 45% by weight, based in each case on the coating material of the invention.

In the case of the preferred embodiment of the coating materials of the invention as one-component systems they contain preferably, based in each case on the solids of a coating material of the invention,
from 10 to 80%, more preferably from 20 to 75%, and in particular from 25 to 70% by weight of binders (A),
from 0.01 to 6%, more preferably from 0.02 to 5%, and in particular from 0.03 to 4% by weight of additive (B), and
from 10 to 80%, more preferably from 20 to 75%, and in particular from 25 to 70% by weight of crosslinking agents (A).

In one particularly preferred embodiment the coating materials of the invention, based on their solids, further contain from 5 to 30%, preferably from 7 to 25%, and in particular from 10 to 20% by weight of at least one rheological assistant, preferably a sag control agent (SCA) (D).

In terms of methods the preparation of the coating materials of the invention has no special features but instead takes place by the mixing and homogenizing of the above-described constituents using conventional mixing techniques and equipment such as stirred tanks, mills with agitator units, extruders, compounders, Ultraturrax, inline dissolvers, static mixers, toothed-wheel dispersers, pressure release nozzles and/or microfluidizers, with actinic radiation excluded where appropriate.

In terms of method the application of the coating materials of the invention has no special features but may instead take place by any conventional application methods suitable for the coating material in question, such as spraying, squirting, knife coating, brushing, pouring, dipping, trickling or rolling, for example. Preference is given to employing spray application methods.

In the case of application of coating materials of the invention that are curable with actinic radiation alone or of dual-cure coating materials of the invention it is advisable to operate in the absence of actinic radiation so as to prevent premature crosslinking.

Curing of the coating materials of the invention takes place generally after a certain rest time or flash-off time. This may have a duration of from 5 s to 2 h, preferably from 1 min to 1 h, and in particular from 1 to 45 min. The rest period serves, for example, for the leveling and devolatilization of the wet films and for the evaporation of the organic solvents present. Flashing off may be accelerated by an elevated temperature but one not high enough for curing.

This process measure can also be employed in the case of wet-on-wet techniques for the drying of the applied paint films, especially electrocoat films, surfacer films and/or basecoat films which are not to be cured or are to be only partly cured.

Thermal curing takes place, for example, with the aid of a gaseous, liquid and/or solid, hot medium, such as hot air, heated oil or heated rollers, or of microwave radiation, infrared and/or near infrared (NIR) light. Preferably heating takes place in a forced-air oven and/or by irradiation of IR and/or NMR lamps. Like the actinic radiation cure, thermal curing may also take place in stages: for example, by running at least one temperature ramp. The thermal cure takes place advantageously at temperatures from room temperature to 200° C.

In the case of curing with actinic radiation, especially UV radiation, it is preferred to employ a dose of from 500 to 4,000, more preferably from 1,000 to 2,900, with particular preference from 1,200 to 2,800, with very particular preference from 1,300 to 2,700, and in particular from 1,400 to 2,600 mJ/cm².

Curing with actinic radiation is carried out using the conventional radiation sources and optical auxiliary measures. Examples of suitable radiation sources are flash lamps from the company VISIT, high or low pressure mercury vapor lamps, which may have been doped with lead in order to open up a radiation window up to 405 nm, or electron beam sources. The arrangement of these sources is known in principle and can be adapted to the circumstances of the workpiece and the process parameters. In the case of workpieces of complex shape, such as are envisaged for automobile bodies, those areas not accessible to direct radiation (shadow regions), such as cavities, folds and other structural undercuts, can be cured using pointwise, small-area or all-round emitters in conjunction with an automatic movement means for the irradiation of cavities or edges. The equipment and conditions for these curing methods are described, for example, in R. Holmes, U. V. and E. B. Curing Formulations for Printing Inks, Coatings and Paints, SITA Technology, Academic Press, London, United Kingdom 1984 or in German patent application DE 198 18 735 A1, column 10, line 31 to column 11, line 16.

Curing here may take place in stages, i.e., by multiple exposure to light or actinic radiation. It may also take place alternatingly, i.e., by curing, for example, alternately with UV radiation and electron beams.

Thermal curing and actinic radiation curing may be employed simultaneously or successively. Where the two curing methods are employed in succession it is possible, for example, to commence with the thermal cure and to end with the actinic radiation cure. In other cases it may prove advantageous to commence with the actinic radiation cure and to end with it.

Curing with actinic radiation is preferably carried out under inert gas, so as to prevent the formation of ozone. Instead of a pure inert gas an oxygen-depleted atmosphere can be used.

“Oxygen-depleted” means that the oxygen content of the atmosphere is lower than that of air (20.95% by volume). The maximum oxygen content of the oxygen-depleted atmosphere is preferably 18%, more preferably 16%, very preferably 14%, more preferably still 10%, and in particular 6.0% by volume. The minimum oxygen content is preferably 0.1%, more preferably 0.5%, very preferably 1.0%, more preferably still 1.5%, and in particular 2.0% by volume.

The above-described methods and apparatus for application and curing can also be employed in the case of noninventive coating materials, such as electrocoat materials, surfacers and/or basecoat materials, which are employed in the production of multicoat color and/or effect paint systems of the invention.

Examples of suitable electrocoat materials and of wet-on-wet techniques are described in Japanese patent application 1975-142501 (Japanese laid-open specification JP 52-065534 A2, Chemical Abstracts No. 87: 137427) or in the patents and patent applications U.S. Pat. No. 4,375,498 A1, U.S. Pat. No. 4,537,926 A1, U.S. Pat. No. 4,761,212 A1, EP 0 529 335 A1, DE 41 25 459 A1, EP 0 595 186 A1, EP 0 074 634 A1, EP 0 505 445 A1,DE42 35 778A1, EP 0 646 420 A1, EP 0 639 660 A1, EP 0 817 648 A1, DE 195 12 017 C1, EP 0 192 113 A2, DE 41 26 476 A1 or WO 98/07794 A1.

Suitable surfacers, also referred to as antistonechip primers or functional coats, are known from patents and patent applications US 4,537,926 A1, EP 0 529 335 A1, EP 0 595 186 A1, EP 0 639 660 A1, DE 44 38 504 A1, DE 43 37 961 A1, WO 89/10387 A1, U.S. Pat. No. 4,450,200 A1, U.S. Pat. No. 4,614,683 A1 or WO 94/26827 A1.

Suitable basecoat materials, especially aqueous basecoat materials, are known from patent applications EP 0 089 497 A1, EP 0 256 540 A1, EP 0 260 447 A1, EP 0 297 576 A1, WO 96/12747, EP 0 523 610 A1, EP 0 228 003 A1, EP 0 397 806 A1, EP 0 574 417 A1, EP 0 531 510 A1, EP 0 581 211 A1, EP 0 708 788 A1, EP 0 593 454 A1, DE 43 28 092 A1, EP 0 299 148 A1, EP 0 394 737 A1, EP 0 590 484 A1, EP 0 234 362 A1, EP 0 234 361 A1, EP 0 543 817 A1, WO 95/14721, EP 0 521 928 A1, EP 0 522 420 A1, EP 0 522 419 A1, EP 0 649 865 A1, EP 0 536 712 A1, EP 0 596 460 A1, EP 0 596 461 A1, EP 0 584 818 A1, EP 0 669 356 A1, EP 0 634 431 A1, EP 0 678 536 A1, EP 0 354 261 A1, EP 0 424 705 A1, WO 97/49745 A11, WO 97/49747 A1, EP 0 401 565 A1 or EP 0 817 684 A1, column 5, lines 31 to 45.

The film thicknesses of the inventive and noninventive coatings are preferably within the ranges normally employed:

Electrocoat:

Preferably from 10 to 60, more preferably from 15 to 50, and in particular from 15 to 40 μm;

Surfacer Coat:

Preferably from 20 to 150, more preferably from 25 to 100, and in particular from 30 to 80 μm;

Basecoat:

Preferably from 5 to 30, more preferably from 7.5 to 25, and in particular from 10 to 20 μm;

Clearcoat:

Preferably from 10 to 100, more preferably from 15 to 80, and in particular from 20 to 70 μm.

The multicoat color and/or effect paint systems of the invention that are obtained are easy to produce and have an outstanding automobile quality. In addition they are free from runs, craters, and areas of dulling. For refinish purposes they can be overcoated easily and without problems.

The coating materials of the invention can also be used, however, as adhesives and sealants for producing adhesive films and seals of the invention and serve for the coating, adhesive bonding and/or sealing of primed or unprimed substrates of metal, plastic, glass, wood, textile, leather, natural stone, artificial stone, concrete, cement or composites of these materials.

The substrates may have been primed. In the case of plastics it is possible to employ conventional primer coats or tie coats as primers or else the plastics surfaces may have been made firmly adhering by flaming or by etching with reactive compounds such as fluorine. In the case of electrically conductive substrates, especially metals, the primers used can be those as described in Römpp Lexikon Lacke und Druckfarben, Georg Thieme Verlag, Stuttgart, New York, 1998, “Primers”, page 473, “Wash Primers”, page 618, or “Shop primer coating”, page 230. In the case of electrically conductive substrates based on aluminum the primer used is preferably an aluminum oxide layer produced by anodic oxidation.

The coating materials, adhesives or sealants of the invention are therefore outstandingly suitable for the coating, adhesive bonding, and sealing of bodies of means of transport, including aircraft, rail vehicles, water craft, and floating structures, muscle-powered vehicles and motor vehicles, both indoors and outdoors, and parts thereof, the interior and exterior of constructions, doors, windows, and furniture, and also for the coating, adhesive bonding, and sealing carried out in the context of the industrial coating of small parts, coils, containers, packaging, electrical, mechanical, and optical components, and also white goods.

Owing to the outstanding performance properties of the coatings, adhesive layers, and seals of the invention the substrates coated, bonded and/or sealed therewith are of particularly long service life and are therefore particularly valuable for the users from an economic, environmental, and technical standpoint.

### EXAMPLES

### Preparation Example 1

The preparation of a Thermally Curable Binder (A)

A laboratory reactor with a capacity of 4 l, equipped with a stirrer, a dropping funnel for the monomer mixture, a dropping funnel for the initiator solution, a nitrogen inlet tube, an internal thermometer, and a reflux condenser, was charged with 883.3 g of an aromatic hydrocarbons fraction having a boiling range of 158 to 172° C. The solvent was heated to 140° C. When this temperature had been reached a monomer mixture of 431.8 g of styrene, 410.3 g of n-butyl acrylate, 244.8 g of hydroxyethyl methacrylate, 172.8 g of n-butyl methacrylate, 158.3 g of 4-hydroxybutyl acrylate, and 21.5 g of acrylic acid was metered in over the course of 4 hours and an initiator solution of 115 g of tert-butyl perethylhexanoate and 62.5 g of the aromatic hydrocarbons fraction was metered in over the course of 4.5 hours, both additions to the initial charge taking place at a uniform rate and with stirring. The addition of the monomer mixture was commenced simultaneously with that of the initiator solution. After the end of the initiator feed the reaction mixture was held at 140° C. for a further 2 hours and then cooled. The resulting methacrylate copolymer solution was adjusted using the aromatic hydrocarbons fraction to a solids content of 60% by weight (forced-air oven: 1 h at 130° C.).

### Preparation Example 2

The preparation of a Urea-Modified Methacrylate Copolymer (Sag Control Agent) (D)

2.1 The Preparation of the Methacrylate Copolymer:

A laboratory reactor with a capacity of 4 l, equipped with a stirrer, a dropping funnel for the monomer mixture, a dropping funnel for the initiator solution, a nitrogen inlet tube, an internal thermometer, and a reflux condenser, was charged with 813 g of an aromatic hydrocarbons fraction having a boiling range of 158 to 172° C. The solvent was heated to 140° C. When this temperature had been reached a monomer mixture of 622 g of styrene, 551 g of n-butyl acrylate, 336 g of hydroxyethyl methacrylate, and 34 g of methacrylic acid was metered in over the course of 4 hours and an initiator solution of 122 g of tert-butyl perethylhexanoate and 46 g of the aromatic hydrocarbons fraction was metered in over the course of 4.5 hours, both additions to the initial charge taking place at a uniform rate and with stirring. The addition of the monomer mixture was commenced simultaneously with that of the initiator solution. After the end of the initiator feed the reaction mixture was held at 140° C. for a further 2 hours and then cooled. The resulting methacrylate copolymer solution was adjusted using the aromatic hydrocarbons fraction to a solids content of 65% by weight (forced-air oven: 1 h at 130° C.).

2.2 The Preparation of Sag Control Agent (D):

A 2 l glass beaker was charged with 508 g of the methacrylate copolymer solution 2.1 and 13.44 g of hexylamine. With vigorous stirring using a laboratory dissolver a solution of 10.56 g of hexamethylene diisocyanate in 68 g of butyl acetate was metered in over the course of 30 minutes. Vigorous stirring of the reaction mixture then continued for 15 minutes. The resultant pseudoplastic, urea-modified methacrylate copolymer solution had a solids content of 65% by weight (forced-air oven: 1 h at 130° C.).

### Preparation Example 3

The Preparation of a Polyamide Wax Paste (A/B)

30 parts by weight of Disparlon® 9600-20X with a solids content of 20% by weight (forced-air oven: 1 h at 130° C.) from Erbslöh and 70 parts by weight of the methacrylate copolymer solution (A) from Preparation Example 1 were mixed and the mixture was homogenized in a laboratory mill.

### Examples 1 to 6 (Inventive) and C1 to C5 (Comparative)

The Preparation of Inventive Coating Materials and Clearcoats (Examples 1 to 6) and of Noninventive Coating Materials and Clearcoats (Examples C1 to C5)

The inventive coating materials of Examples 1 to 6 (cf. Table 1) and the noninventive coating materials of Examples C1 to C5 (cf. Table 2) were prepared by mixing their constituents and homogenizing the resulting mixtures.

The resultant inventive and noninventive coating materials were applied in the form of wedges to metal test panels. The panels were perforated. The perforations were arranged in the form of a series of holes parallel to the film-thickness gradient and near to an edge parallel thereto. The coated test panels with parallel hole series were fixed in a vertical position, in which the vector of the force of gravity forms an angle of 0° with a line of height and an angle of 90° with the film-thickness gradient. The wedge-shaped films applied were subsequently dried at room temperature for 10 minutes and cured at 140° C. for 30 minutes. Tables 1 and 2 report the wet film thicknesses from which runs develop beneath the holes owing to the film thickness, the force of gravity, and inadequate adhesion to the test panel.

A comparison of the results of Table 1 with the results of Table 2 shows that the inventive clearcoats, in contrast to their noninventive counterparts, showed no pops and no instances of dulling and possessed a significantly higher run limit.

TABLE 1
The composition of the inventive coating materials of Examples
1 to 6 and the performance properties of the clearcoats
produced from them

| | Examples: | | | | | |
|---|---|---|---|---|---|---|
| | 1 | 2 | 3 | 4 | 5 | 6 |
| Clearcoat material: | | | | | | |
| Binder^{a)} | 31.5 | 37 | 28 | 49.5 | 40.5 | 46 |
| Polyamide wax paste^{b)} | 5 | 10 | 10 | 5 | 5 | 10 |
| Crosslinking agent 1^{c)} | 6.1 | 6.1 | 6.1 | 6.1 | 6.1 | 6.1 |
| Crosslinking agent 2^{d)} | 13.2 | 13.2 | 13.2 | 13.2 | 13.2 | 13.2 |
| Sag Control Agent^{e)} | 18.6 | 9.3 | 18.6 | — | 9.3 | 9.8 |
| Crosslinking agent 3^{f)} | 9.8 | 9.8 | 9.8 | 9.8 | 9.8 | 9.8 |
| 2,5-Diethyloctanediol | 2.5 | 2.5 | 2.5 | 2.5 | 2.5 | 2.5 |
| Tinuvin ® 400^{g)} | 1 | 1 | 1 | 1 | 1 | 1 |
| Tinuvin ® 123^{h)} | 0.6 | 0.6 | 0.6 | 0.6 | 0.6 | 0.6 |
| Byk ® 390ⁱ⁾ | 0.005 | 0.005 | 0.005 | 0.005 | 0.005 | 0.005 |
| Byk ® 310^{j)} | 0.1 | 0.1 | 0.1 | 0.1 | 0.1 | 0.1 |
| Petroleum spirit 180/210 | 1.7 | 1.7 | 1.7 | 1.7 | 1.7 | 1.7 |
| Butyldiglycol acetate | 4 | 4 | 4 | 4 | 4 | 4 |
| Butanol | 6 | 6 | 6 | 6 | 6 | 6 |
| Solventnaphtha ® | 1.045 | 1.045 | 1.045 | 1.045 | 1.045 | 1.045 |
| Xylene | 0.35 | 0.35 | 0.25 | 0.35 | 0.35 | 0.35 |
| Standardizer^{k)} | 12 | 14 | 14 | 8 | 9 | 14 |
| Solids content (wt. %) | 46.6 | 45 | 46.2 | 48.3 | 47.6 | 46.1 |
| Clearcoat: | | | | | | |
| Dulling | none | none | none | none | none | none |
| Pops | none | none | none | none | none | none |
| Runs: | | | | | | |
| Start (μm)^{l)} | 58 | 42 | 59 | 37 | 39 | 36 |
| 5 mm (μm)^{l)} | 59 | 44 | 60 | 39 | 42 | 42 |
| 10 mm (μm)^{l)} | 61 | 49 | 68 | 43 | 46 | 45 |

^{a)}methacrylate copolymer solution (A) from Preparation Example 1;
^{b)}polyamide wax paste from Preparation Example 3;
^{c)}malonate-blocked polyisocyanate based on hexamethylene diisocyanate, solids content 68% by weight;
^{d)}malonate-blocked polyisocyanate based on isophorone diisocyanate, solids content 63% by weight;
^{e)}urea-modified methacrylate copolymer solution (D) from Preparation Example 2;
^{f)}commercial melamine resin, solids content 90% by weight (Cymel ® 327 from CYTEC);
^{g)}commercial light stabilizer from Ciba Specialty Chemicals;
^{h)}commercial light stabilizer from Ciba Specialty Chemicals;
ⁱ⁾commercial coatings additive from Byk Chemie;
^{j)}commercial coatings additive from Byk Chemie;
^{k)}aromatic solvent mixture for adjusting the solids content of solventborne coating materials; secondary components: esters;
^{l)}film thickness of the clearcoat.

TABLE 2
The composition of the inventive coating materials of Examples
C1 to C5 and the performance properties of the clearcoats
produced from them

| | Examples: | | | | |
|---|---|---|---|---|---|
| | C1 | C2 | C3 | C4 | C5 |
| Clearcoat material: | | | | | |
| Binder^{a)} | 35 | 53 | 35 | 53 | 44 |
| Crosslinking agent 1^{c)} | 6.1 | 6.1 | 6.1 | 6.1 | 6.1 |
| Crosslinking agent 2^{d)} | 13.2 | 13.2 | 13.2 | 13.2 | 13.2 |
| Sag Control Agent^{e)} | 18.6 | — | 18.6 | — | 9.3 |
| Crosslinking agent 3^{f)} | 9.8 | 9.8 | 9.8 | 9.8 | 9.8 |
| 2,5-Diethyloctanediol | 2.5 | 2.5 | 2.5 | 2.5 | 2.5 |
| Tinuvin ® 400^{g)} | 1 | 1 | 1 | 1 | 1 |
| Tinuvin ® 123^{h)} | 0.6 | 0.6 | 0.6 | 0.6 | 0.6 |
| Byk ® 390ⁱ⁾ | 0.005 | 0.005 | 0.005 | 0.005 | 0.005 |
| Byk ® 310^{j)} | 0.1 | 0.1 | 0.1 | 0.1 | 0.1 |
| Petroleum spirit 180/210 | 1.7 | 1.7 | 1.7 | 1.7 | 1.7 |
| Butyldiglycol acetate | 4 | 4 | 4 | 4 | 4 |
| Butanol | 6 | 6 | 6 | 6 | 6 |
| Solventnaphtha ® | 1.045 | 1.045 | 1.045 | 1.045 | 1.045 |
| Xylene | 0.35 | 0.35 | 0.25 | 0.35 | 0.35 |
| Standardizer^{k)} | 8 | 6 | 7 | 6 | 7 |
| Solids content (wt. %) | 48.8 | 49.9 | 49.8 | 50.1 | 50.4 |
| Clearcoat: | | | | | |
| Dulling | yes | none | yes | none | slight |
| Pops | slight | yes | yes | yes | yes |
| Runs: | | | | | |
| Start (μm)^{l)} | 44 | 28 | 48 | 30 | 36 |
| 5 mm (μm)^{l)} | 45 | 30 | 50 | 33 | 37 |
| 10 mm μm)^{l)} | 53 | 36 | 52 | 36 | 41 |

^{a)}methacrylate copolymer solution (A) from Preparation Example 1;
^{c)}malonate-blocked polyisocyanate based on hexamethylene diisocyanate, solids content 68% by weight;
^{d)}malonate-blocked polyisocyanate based on isophorone diisocyanate, solids content 63% by weight;
^{e)}urea-modified methacrylate copolymer solution (D) from Preparation Example 2;
^{f)}commercial melamine resin, solids content 90% by weight (Cymel ® 327 from CYTEC);
^{g)}commercial light stabilizer from Ciba Specialty Chemicals;
^{h)}commercial light stabilizer from Ciba Specialty Chemicals;
ⁱ⁾commercial coatings additive from Byk Chemie;
^{j)}commercial coatings additive from Byk Chemie;
^{k)}aromatic solvent mixture for adjusting the solids content of solventborne coating materials; secondary componenets: esters;
^{l)}film thickness of the clearcoat.

1. A solventborne coating material curable thermally and/or with actinic radiation and free from hiding pigments, comprising
(A) at least one constituent selected from the group consisting of low molecular mass, oligomeric, and polymeric binders, crosslinking agents, and reactive diluents curable thermally, with actinic radiation, or both thermally and with actinic radiation;
and
(B) from 0.01 to 4% by weight, based on the coating material, of dispersed synthetic polyamide wax particles.

2. The coating material as claimed in claim 1, wherein the synthetic polyamide wax particles (B) have been swollen.

3. The coating material as claimed in claim 1 or 2, wherein the synthetic polyamide wax particles (B) have a melting point or melting range of above 100° C.

4. The coating material as claimed in claim 1, wherein the synthetic polyamide wax particles (B) have a melting point or melting range of below 200° C.

5. The coating material as claimed in claim 1, wherein the synthetic polyamide wax particles (B) have an average particle size below the film thickness of the coating produced from the coating material.

6. The coating material as claimed in claim 1, wherein the average particle size of the synthetic polyamide wax particles (B) is below 100 μm.

7. The coating material as claimed in claim 6, wherein the average particle size of the synthetic polyamide wax particles (B) is between 5 to 40 μm.

8. The coating material as claimed in claim 1, wherein the synthetic polyamide wax particles are present in an amount, based on the coating material, of from 0.05 to 2.2% by weight.

9. The coating material as claimed in claim 1, which is a thermally curable one-component system.

10. A process for preparing a solventborne coating material curable thermally and/or with actinic radiation, as claimed in claim 1, which comprises adding the synthetic polyamide wax particles in the form of organic dispersions or pastes.

11. The process as claimed in claim 10, wherein the organic dispersions contain the synthetic polyamide wax particles in an amount, based on their total amount, of from 5 to 40% by weight and the pastes, based on their solids, contain from 20 to 60% by weight of binders (A) and from 3 to 9% by weight of polyamide wax particles (B).

12. At least one of a coating material, adhesive of and sealant comprising the coating material of claim 1.

13. A paint system which is one of a single-coat clearcoat system, multicoat clearcoat system, multicoat color system, effect paint system, and multicoat color and effect paint system comprising the coating material of claim 1.

14. A means of transport, including aircraft, rail vehicles, water craft, muscle-powered vehicles and motor vehicles, in the interior and exterior areas, and also parts thereof, the interior and exterior of constructions, doors, windows, and furniture, small parts, coils, containers, packaging, electrical, mechanical, and optical components, and also white goods comprising at least one of the coating material, adhesive or sealant of claim 12.
